(19) United States
(12) Patent Application Publication
(10) Pub. No.: US 2006/0279168 A1
(43) Pub. Date: Dec. 14, 2006

(54) Laser scanner having low dynamic deformation

(75) Inventor: Jin-Woo Cho, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/397,615

(22) Filed: Apr. 5, 2006

(30) Foreign Application Priority Data
May 31, 2005 (KR) 10-2005-0046129

(51) Int. Cl. H02N 1/00

(52) U.S. Cl. 310/309

(57) ABSTRACT

A laser scanner with a low dynamic deformation. The laser scanner includes: a stage which rotates about an axis of rotation and which has a first surface on which a mirror surface is formed; and torsion springs which support both sides of the stage and which act as the axis of rotation, wherein the stage has a second surface on which etched portions are formed to a predetermined depth, and the etched portions are formed by removing sections of the second surface in the order of their influence on a dynamic deformation of the stage driven at a resonant frequency to minimize the dynamic deformation.

### CROSS-REFERENCE TO RELATED PATENT APPLICATION

This application claims priority from Korean Patent Application No. 10-2005-0046129, filed on May 31, 2005, in the Korean Intellectual Property Office, the disclosure of which is incorporated herein in its entirety by reference.

### BACKGROUND OF THE INVENTION

1. Field of the Invention

The present invention relates to a micro-electro-mechanical system (MEMS) laser scanner and, more particularly, to a laser scanner including a stage whose bottom surface is removed to increase a driving angle of the stage and minimize a dynamic deformation of the stage.

2. Description of the Related Art

Laser scanners can be used for large display devices to scan a laser beam. In laser scanners, the driving speed of an actuator relates to the resolution of a display device, and the driving angle of the actuator relates to the screen size of the display device. That is, as the driving speed of the optical scanner increases, resolution increases. Also, as the driving angle of the optical scanner increases, the screen size of the display device increases. Accordingly, in order to realize large display devices with high resolution, laser scanners including an actuator need to operate at high speed and have a high driving angle. However, since the driving speed and the driving angle of the actuator are in a trade-off relation, there is a limitation in increasing both the driving speed and the driving angle of the actuator.

The motion equation of a stage is as follows.
I\ddot{θ}+C\dot{θ}+Kθ=M (1)
where I denotes the moment of inertia of the stage,θdenotes a driving angle, C denotes a damping coefficient, K denotes a torsion spring constant, and M denotes a torque produced by a driving voltage.

The natural frequency of the stage is as follows.

$$f = \frac{1}{2 π} \sqrt{\frac{k}{I}} \qquad ( 2 )$$

where f denotes the frequency.

Accordingly, when the same natural frequency is used, as the moment of inertia I decreases, the torsion spring constant K decreases such that a large driving angle can be achieved with a small force.

Japanese Patent Publication No. 2001-249300 discloses a laser scanner which reduces the moment of inertia by etching a rear surface of a stage to geometrically uniformly form a plurality of grooves. The laser scanner disclosed in Japanese Patent Publication No. 2001-249300 can reduce a static deformation of the stage but rarely reduce a dynamic deformation accompanied by an angular acceleration generated during a high speed driving of 33.75 kHz. Accordingly, an image of a display may be distorted due to the dynamic deformation of the stage when the laser scanner operates at high speed.

### SUMMARY OF THE INVENTION

An apparatus consistent with the present invention relates to a laser scanner, which can increase a driving angle during a resonant driving and reduce a dynamic deformation of a stage.

According to an aspect of the present invention, there is provided a laser scanner with a low dynamic deformation, the laser scanner comprising: a stage which rotates about an axis of rotation and which has a first surface on which a mirror surface is formed; and torsion springs which support both sides of the stage and which act as the axis of rotation, wherein the stage has a second surface on which etched portions are formed to a predetermined depth, and the etched portions are formed by removing sections of the second surface in the order of their influence on a dynamic deformation of the stage driven at a resonant frequency to minimize the dynamic deformation.

The stage may be formed of a plurality of silicon layers and insulation layers formed between the silicon layers, and the etched portions may be formed on the silicon layer of the second surface among the plurality of silicon layers.

The etched portions may be formed by etching 10 to 40% of the second surface.

Portions other than the etched portions may include first portions that are connected to the torsion springs and are spaced apart from each other.

The portions other than the etched portions may include second portions that are formed from a portion between outside the first portions and are spaced apart from each other.

The portions other than the etched portions may include an etched third portion surrounded by the first and second portions that are connected to each other.

The laser scanner may further comprise etched fourth portions formed at opposite circumferential portions outside the second portions.

### BRIEF DESCRIPTION OF THE DRAWINGS

The above and other features and advantages of the present invention will become more apparent by describing in detail exemplary embodiments thereof with reference to the attached drawings, in which:

FIG. 1 is a perspective view of a stage of a conventional laser scanner;

FIG. 2 is a graph illustrating simulation results illustrating a dynamic deformation of the stage of the conventional laser scanner of FIG. 1;

FIG. 3 is a perspective view illustrating a topology optimization method used in the present invention;

FIG. 4 is a perspective view of a stage having a first layer, of which about 20% is removed using topology optimization;

FIGS. 5A through 5E, are perspective views of the stage having the first layer, of which 10 to 80% are removed using topology optimization;

FIG. 6 is a plotting graph illustrating the moment of inertia according to the first layer removal rate of the stage; and

FIG. 7 is a plotting graph illustrating a dynamic deformation of the stage according to the first layer removal rate of the stage.

### DETAILED DESCRIPTION OF THE ILLUSTRATIVE, NON-LIMITING EMBODIMENTS OF THE INVENTION

The present invention will now be described more fully with reference to the accompanying drawings, in which illustrative, non-limiting embodiments of the invention are shown. In the following description of the present invention, the sizes of constituent elements shown in the drawings may be exaggerated, if needed, or sometimes the elements may be omitted for a bettering understanding of the present invention. However, such ways of description do not limit the scope of the technical concept of the present invention.

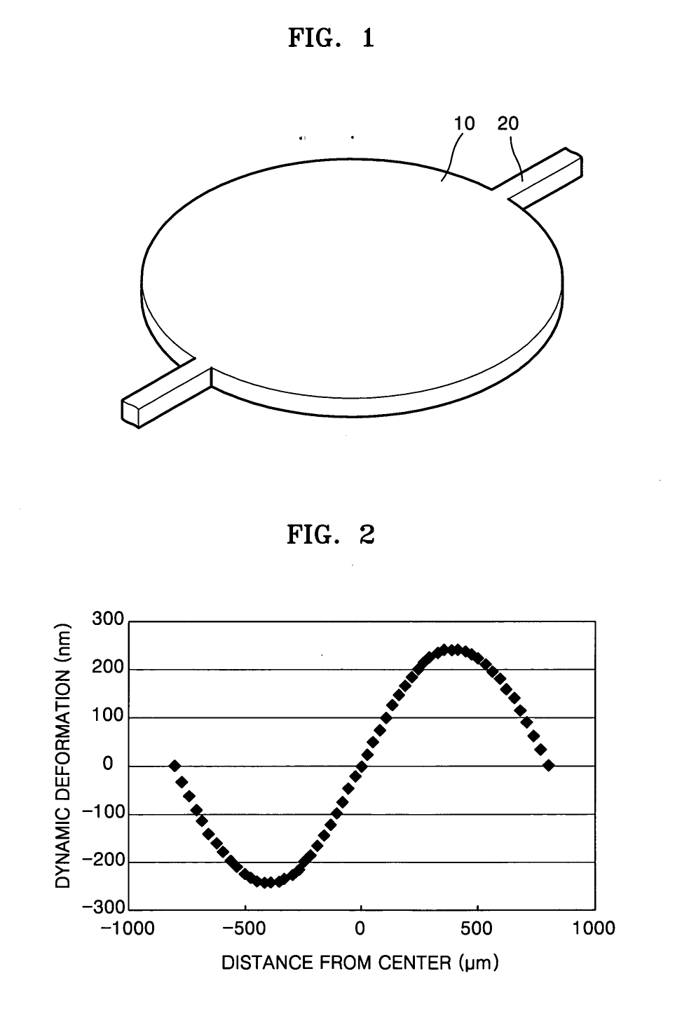

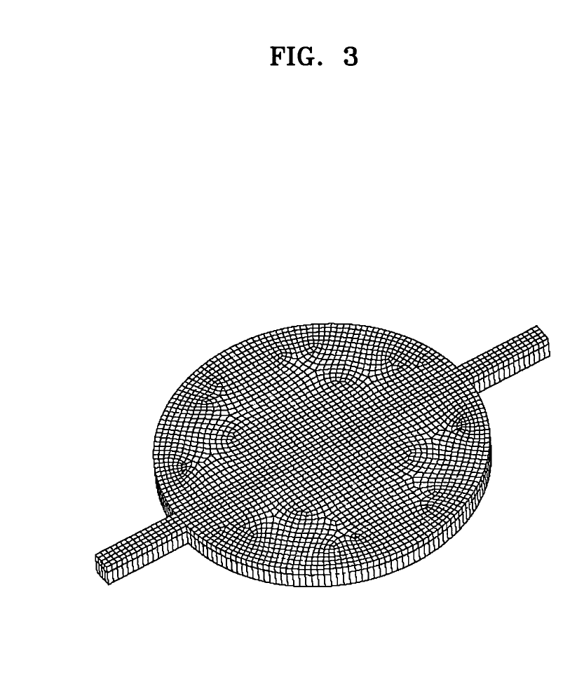

FIG. 1 is a perspective view of a stage of a conventional laser scanner. FIG. 2 is a graph illustrating simulation results illustrating a dynamic deformation of the stage of the conventional laser scanner of FIG. 1.

Referring to FIG. 1, torsion springs 20 acting as an axis of rotation are connected to both sides of a circular stage 10 to support both sides of the stage 10. The stage 10 has a diameter of 1.6 mm and a thickness of 124 μm. A top surface of the stage 10 has a mirror surface (not shown), and the stage 10 is formed of three silicon layers and insulation layers between the silicon layers. Each of the silicon layers has a thickness of 40 μm, and each of the insulation layers has a thickness of 2 μm. The stage 10 is driven at a driving speed of 33.75 kHz and a driving angle of 16°.

Referring to FIG. 2, a maximum dynamic deformation of 230 nm has occurred at the driving angle of 16°.

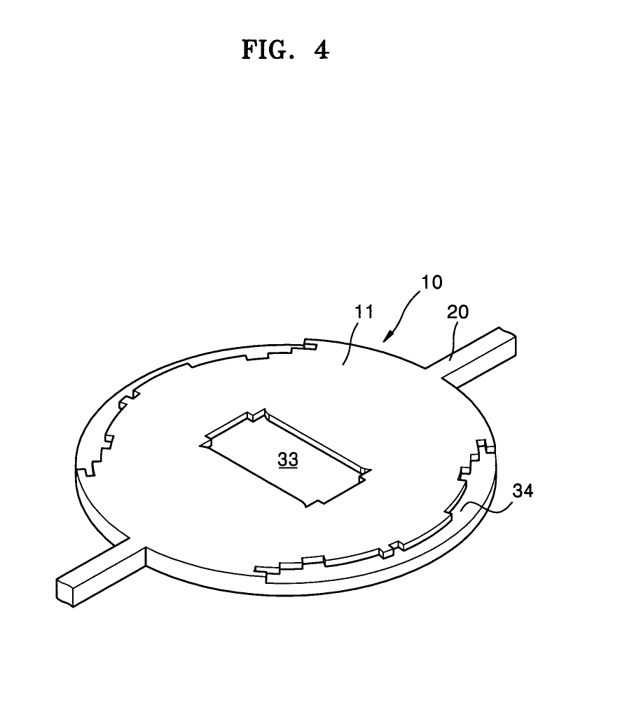

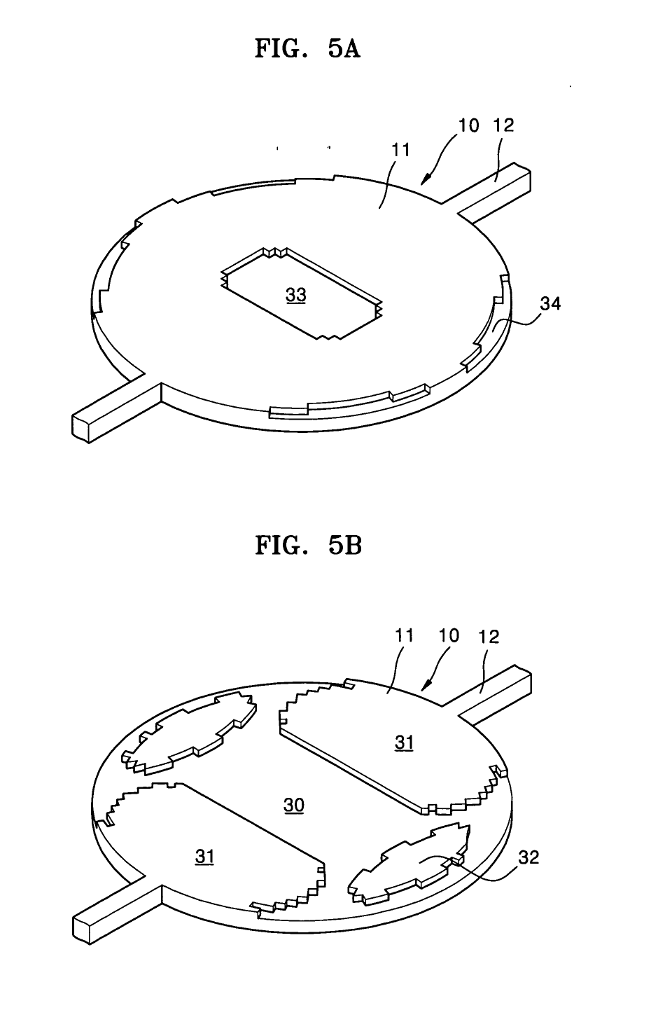

FIG. 3 illustrates a topology optimization method used in the present invention. The simulation was performed using an ANSYS element analysis program. Referring to FIG. 3, a first silicon layer 11 (see FIG. 4), opposite to the mirror surface of the stage 10, was divided into many sections, and then when one section is removed, a dynamic deformation was calculated to grade the section according to the dynamic deformation. Thereafter, the sections are removed in the order of their influence on the dynamic deformation.

FIG. 4 is a perspective view of the stage including the first layer 11, of which 20% is removed using topology optimization. Referring to FIG. 4, since a rectangular central portion 33 and circumferential edge portions 34 between the torsion springs 20 are less dedicated to the stiffness of the stage 10, dynamic deformations of them are high. The central portion 33 and the edge portions 34 will be explained later.

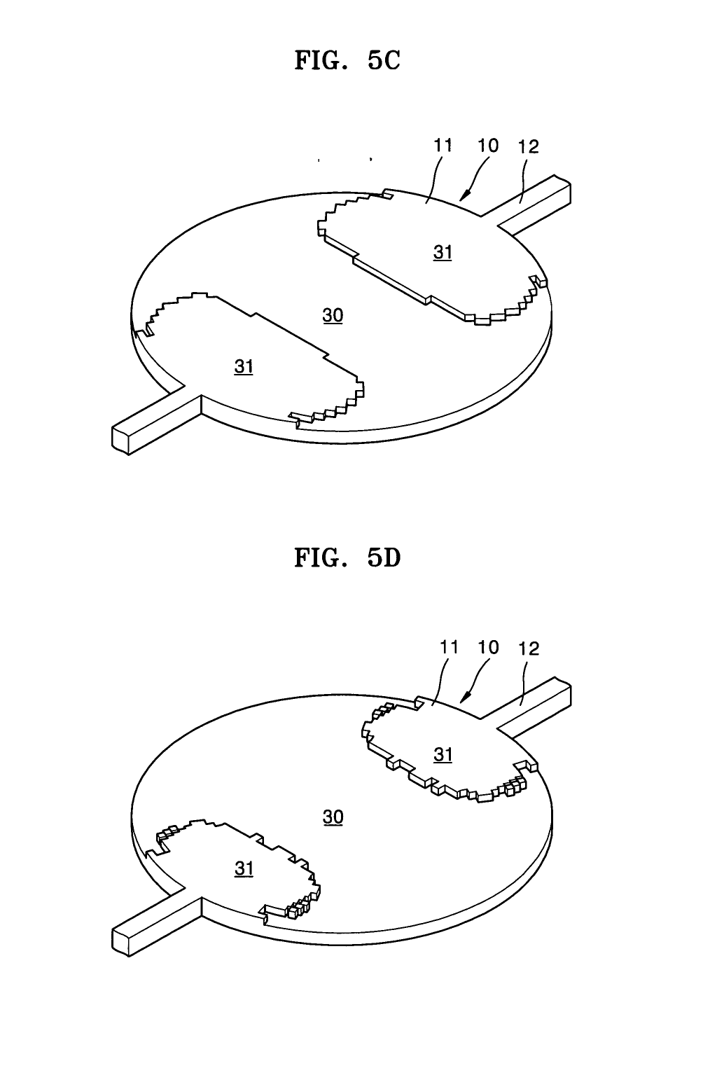

FIGS. 5A through 5E are perspective views of the stage 10 including the first layer 11, of which 10 to 80% is removed using topology optimization.

Referring to FIGS. 5C through 5E, first portions 31, other than an etched portion 30, remaining after 40, 60, and 80% of the first layer 11 of the stage 10 is removed respectively, contact the torsion springs 20 and are spaced apart from each other. The first portions 31 constantly increase from the case where 80% of the first layer 11 of the stage 10 is removed to the case where 40% of the first layer 11 of the stage 10 is removed.

Referring to FIG. 5B, the first portions 31 and second portions 32 remain after 30% of the first layer 11 of the stage 10 is removed, such that the second portions 32 are formed outside from a portion between the first portions 31 to be spaced apart from each other. The second portions 32 are also spaced apart from the circumference of the stage 10.

Referring to FIG. 4, when 20% of the fist layer 11 of the stage 10 is removed, the second portions 32 and the first portions 31 (see FIG. 5B) increase to be connected to each other, such that the etched rectangular third portion 33 is formed inside the second and first portions 32 and 31. The third portion 33 has a rectangular shape elongated in a direction perpendicular to the axis of rotation, that is, the torsion springs 20. The etched fourth portions 34 are formed at opposite circumferential edge portions between the torsion springs 20.

Referring to FIG. 5A, the third portion 33 and the fourth portions 34 are reduced when 10% of the first layer 11 of the stage 10 is removed.

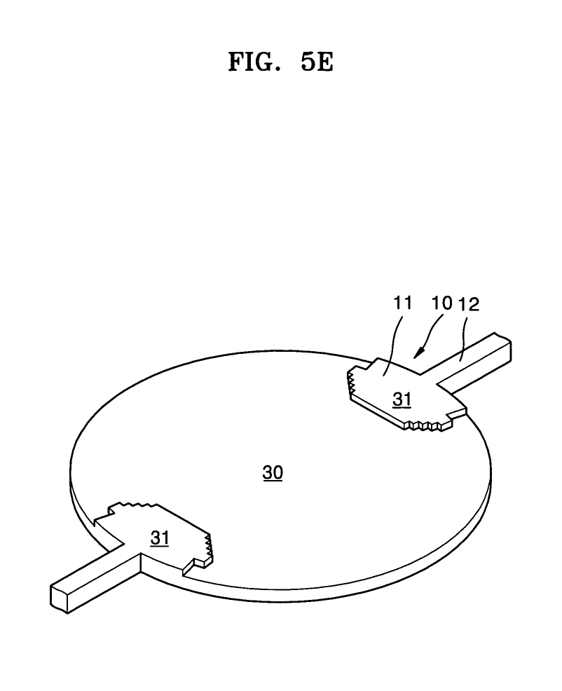

FIG. 6 is a plotting graph illustrating the moment of inertia according to the first layer removal rate of the stage 10. Referring to FIG. 6, the moment of inertia is linearly reduced until 40% of the first layer 11 of the stage 10 is removed. The decrease in the moment of inertial may result in an increase in a driving angle. In the meantime, the decrease in the moment of inertia becomes less steep when 40% or more of the first layer 11 of the stage 10 is removed.

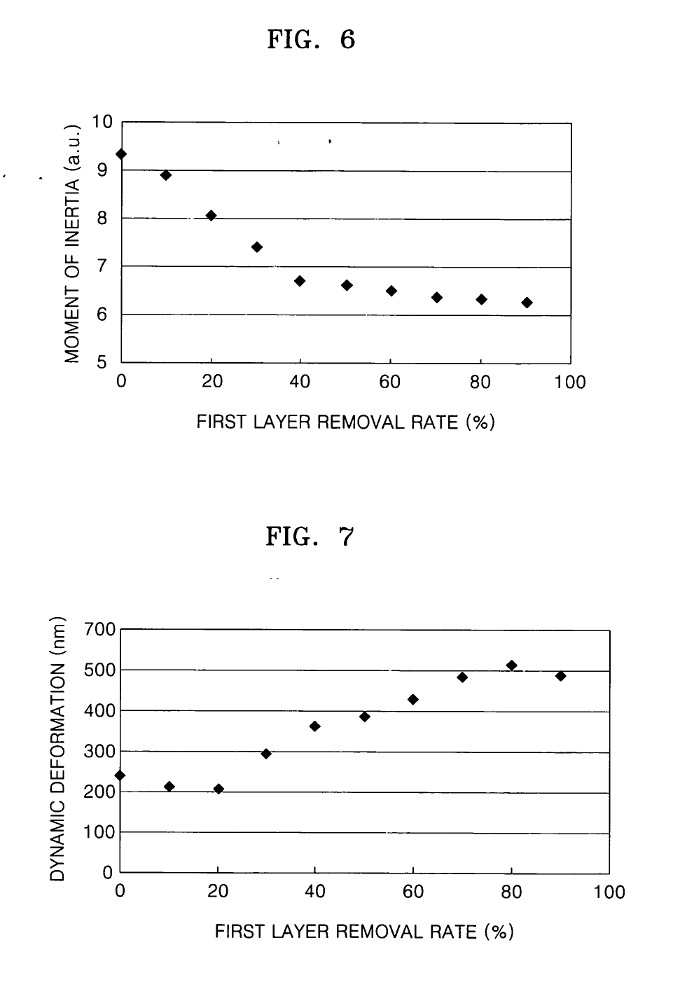

FIG. 7 is a plotting graph illustrating a dynamic deformation of the stage according to the first layer removal rate of the stage 10. Referring to FIG. 7, the dynamic deformation is reduced due to the decrease in the moment of inertia until 20% of the first layer 11 of the stage 10 is removed, whereas the stiffness of the stage 10 is reduced when 30% or more of the first layer 11 of the stage 10 is removed, thereby increasing the dynamic deformation.

As it is found from the graphs of FIGS. 6 and 7, it is preferable, but not necessary, that approximately 10 to 40% of the first layer 11 be removed in view of the decrease in the dynamic deformation and the increase in the driving angle.

Although the stage 10 includes three silicon layers and insulation layers formed between the silicon layers and among the silicon layers, the lower silicon layer, i.e., the first layer 11, is etched using the insulation layer as an etch stop to ensure a constant etch depth, the present invention is not limited thereto. That is, the stage 10 may be a silicon wafer, a mask may be formed on the wafer, and an exposed portion of the wafer may be etched for a predetermined period of time to ensure a constant etch depth.

Also, the stage 10 may include two silicon layers and an insulation layer disposed between the two silicon layers, and the lower silicon layer may be etched using the insulation layer as an etch stop.

As described above, the laser scanner according to the present invention can minimize a dynamic deformation and increase a driving angle by removing portions of a bottom surface, which affect less the stiffness of the stage.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A laser scanner with a low dynamic deformation, the laser scanner comprising:
a stage which rotates about an axis of rotation and which has a first surface on which a mirror surface is formed; and
torsion springs which support both sides of the stage and which act as the axis of rotation,
wherein the stage has a second surface on which etched portions are formed to a predetermined depth, and the etched portions are formed by removing sections of the second surface in the order of their influence on a dynamic deformation of the stage driven at a resonant frequency to minimize the dynamic deformation.

2. The laser scanner of claim 1, wherein the stage is formed of a plurality of silicon layers and insulation layers formed between the silicon layers, and the etched portions are formed on the silicon layer of the second surface among the plurality of silicon layers.

3. The laser scanner of claim 1, wherein the etched portions are formed by etching 10 to 40% of the second surface.

4. The laser scanner of claim 1, wherein portions other than the etched portions include first portions that are connected to the torsion springs and are spaced apart from each other.

5. The laser scanner of claim 4, wherein the portions other than the etched portions include second portions that are formed outside from a portion between the first portions and are spaced apart from each other.

6. The laser scanner of claim 5, wherein the portions other than the etched portions include an etched third portion surrounded by the first and second portions that are connected to each other.

7. The laser scanner of claim 6, wherein the third portion has a rectangular shape.

8. The laser scanner of claim 7, wherein the third portion has a rectangular shape elongated in a direction perpendicular to the axis of rotation.

9. The laser scanner of claim 6, further comprising etched fourth portions formed at opposite circumferential portions outside the second portions.
